(19) United States
(12) Patent Application Publication
(10) Pub. No.: US 2003/0224096 A1
(43) Pub. Date: Dec. 4, 2003

(54) Whey protein hydrolysate

(75) Inventors: Thomas Lykke Sorensen, Raleigh, NC (US); Sabry A. Madkor, Raleigh, NC (US); Sonya Mims, Raleigh, NC (US)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/161,827

(22) Filed: Jun. 4, 2002

(51) Int. Cl. A23C 19/00

(52) U.S. Cl. 426/582

(57) ABSTRACT

The present invention relates to a method for hydrolysing whey proteins by a metaloprotease. The invention also relates to the hydrolysate obtained and the use of the hydrolysate as a food ingredient. The invention further relates to a food product obtained by using the whey protein hydrolysate as an ingredient.

### TECHNICAL FIELD

The present invention relates to a whey protein hydrolysate produced by treating a whey protein preparation with a metaloprotease and the use of the resulting hydrolysate as a food ingredient.

### BACKGROUND OF THE INVENTION

In traditional cheesemaking, milk is coagulated by acidification or the combination of acidification and addition of rennet. When a curd with the desired consistency and strength has been obtained, the curd is cut, followed by separation of whey from the curd, e.g. by draining, and the fresh curd is further processed, e.g. by pressing, salting and ripening, to form the finished cheese.

In this process, a considerable loss of milk proteins takes place due to the removal of the whey protein with the whey. The whey proteins can be recovered from the whey and processed into whey protein preparations such as e.g. Whey Protein Concentrates (WPC) and Whey Protein Isolates (WPI). Such whey protein preparations can be used as ingredients food products.

EP 1048219 discloses cheese containing a whey protein digestion product. The digestion product is produced by the action of a non-rennet protease on whey proteins and subsequently incorporated into the cheese.

However, incorporation of high amounts of whey protein preparations into food products can induce undesirable properties of the food products. High amounts of whey protein can impart an unacceptable taste, e.g. caused by denatured whey proteins, and unacceptable texture.

In cheeses the inclusion of whey proteins can result in reduced ability to melt and/or to flow upon heating (see e.g. Hickey, M. W. & Versteeg, C. (1993) Mozzarella cheese with ultrafiltrate retentate. The Australian J. Dairy Technology). Impaired melting ability is a problem in cheeses made for use as an ingredient in food that is heated, e.g. Pizza Cheese, Mozzarella and the like, where the ability to melt and flow upon heating is desired.

Cheeses based on whey protein, such as Ricotta type cheeses, often display a moist curd that lack the smoothness and cohesiveness of traditional cheeses and has a more grainy and fragile texture. An improved texture would facilitate a wider use of these cheeses as a food ingredient. There is thus a need for a whey protein preparation with improved taste and texture for use as a food ingredient.

### SUMMARY OF THE INVENTION

According to the invention it has been found that using a metaloprotease for hydrolysis of whey proteins affects the taste and texture of the resulting whey protein hydrolysate.

Thus, the invention relates to a method for producing a whey protein hydrolysate comprising, a) adding a metaloprotease to a composition comprising whey protein, b) heat treating said composition at a temperature of between 80 and 98° C.

The invention further relates to a whey protein hydrolysate produced by the above method.

In another aspect, the invention relates to a method for producing a food product using the above whey protein hydrolysate as an ingredient, and in a yet further aspect, the invention relates to the food product produced by said method.

### DETAILED DESCRIPTION OF THE INVENTION

A method for producing a whey protein hydrolysate comprising, a) adding a metaloprotease to a composition comprising whey protein, b) heat treating said composition at a temperature of between 80 and 98° C.

Whey Protein Composition

A composition comprising whey protein according to the invention may be any composition comprising whey protein such as milk, cream and cheese whey. Whey derived from any cheese source may be used, including cheddar cheese, Swiss cheese, mozzarella cheese and the like. A composition comprising whey protein may be any aqueous solution comprising whey protein. The whey protein may be obtained by any method known in the art. Preferably, whey protein is obtained by one or more of ultrafiltration, electrodialysis, evaporation, and reverse osmosis of cheese whey. See, e.g., U.S. Pat. No. 3,547,900 and Horton et al., Food Technol., 26:30 (1972). Whey protein preparations, which typically contain beta-lactoglobulin and/or alpha-lactalbumin, are commercially available as whey protein concentrates (WPC) or whey protein isolates (WPI), from, e.g., Davisco (Le Sueur Minn.); Bio-lsolates PLC (Deeside, UK); NZMP North America (Santa Rosa Calif.); Formost Farms (Baraboo Wis.); Arla Foods (Union N.J.); and Avenmore Waterford (Monroe Wis.). In a preferred embodiment, the composition comprising whey protein is obtained by dissolving a whey protein concentrate or a whey protein isolate, in water at a concentration corresponding to between 1% and 60% w/w protein, preferably about 5 to 50%, and most preferably about 20 to 40%.

In a preferred embodiment the pH of the composition comprising whey protein is between 4 and 9, such as between 5 and 8, preferably between 6 and 7.

Metaloproteases

Metaloproteases according to the invention are proteases that require zinc or metal ions for catalysis. In a preferred embodiment the metaloprotease is an endopeptidase. In another preferred embodiment the metaloprotease belongs to peptidase family M4, also known as thermolysin-like proteases. In a further preferred embodiment the metaloprotease is derived from Bacillus amyloliquefaciens

An example of a metaloprotease according to the invention is NS46013 (Novozymes A/S, Denmark).

The amount of the metaloprotease added to the composition comprising whey protein, the temperature of the composition, and the time the metaloprotease is incubated with the composition before heat treatment, may be determined by methods well known in the art to give the optimal effect, and may vary depending on the enzyme and the nature of the composition comprising whey protein.

The acitivity of the metaloprotease may be expressed in Anson Units (AU). One Anson Unit is defined as the amount of enzyme which under optimal conditions digests haemoglobin at an initial rate, so that there is liberated per minute an amount of TCA soluble product which gives the same colour with phenol reagent as one milliequivalent of tyrosine.

In a preferred embodiment the amount of enzyme added to the composition comprising whey protein is between 0.01 and 10 AU pr g whey protein, such as between 0.1 and 5 AU pr g whey protein, preferably between 0.2 and 2 AU per g whey protein.

In a preferred embodiment the metaloprotease is incubated with the composition comprising whey protein at a temperature between 10 and 70° C., such as between 20 and 60° C., preferably between 30 and 60° C., for 10 min to 5 hours, such as 30 min to 3 hours, preferably 30 min to 2 hours.

Heat Treatment

After the metaloprotease has been allowed to react with the composition comprising whey protein the composition is subjected to a heat treatment. In a preferred embodiment the heat treatment is conducted at a temperature between 80 and 98° C., such as between 85 and 95° C., for between 1 and 60 min, such as between 10 and 60 min, preferably between 20 and 40 min. In another preferred embodiment the heat treatment is conducted at a temperature and time combination sufficient to inactivate the enzyme. In a further preferred embodiment the heat treatment is conducted at a temperature and time combination sufficient to induce gelation of the composition. Gelation can be defined as the loss of solubility of heat denatured whey proteins due to unfolding of protein and or peptide molecules. Gelation can be determined by observing the changes from a liquid solution to a coagulated gelatinous curd.

In one embodiment the hydrolysate is further subjected to a homogenisation step after heat treatment.

A further aspect of the invention relates to the whey protein hydrolysate obtainable by the method of the invention.

Another further aspect of the invention relates to the use of the whey protein hydrolysate of the invention as an ingredient in a food product.

Cheesemaking

In one embodiment of the invention the whey protein hydrolysate is used as an ingredient in production of cheese. In the present context, the term “cheese” refers to any kind of cheese and such as, e.g., natural cheese, cheese analogues and processed cheese. The cheese may be obtained by any suitable process known in the art, such as, e.g., by enzymatic coagulation of the cheese milk with rennet, or by acidic coagulation of the cheese milk with food grade acid or acid produced by lactic acid bacteria growth. In one embodiment, the cheese manufactured by the process of the invention is rennet-curd cheese. Rennet is commercially available, e.g. as Naturen® (animal rennet), Chy-max® (fermentation produced chymosin), Microlant® (Microbial coagulant produced by fermentation), all from Chr. Hansen A/S, Denmark. The cheese milk may be subjected to a conventional cheese-making process.

In one embodiment the cheese is produced for use as a food ingredient.

In a preferred embodiment the cheese is Pizza cheese. Pizza cheese as used herein includes cheeses suitable for pizzas and is usually stretched curd (pasta filata) cheeses. Stretched curd cheeses, e.g. Mozzarella, are normally distinguished by a unique plasticizing and kneading treatment of the fresh curd in hot water, which imparts the finished cheese its characteristic fibrous structure and melting and stretching properties, cf. e.g. “Mozzarella and Pizza cheese” by Paul S. Kindstedt, Cheese: Chemistry, physics and microbiology, Volume 2: Major Cheese groups, second edition, page 337-341, Chapman & Hall.

In another preferred embodiment the cheese is fresh acid curd cheese. Fresh acid curd cheeses are produced by coagulating milk, cream, whey, or any combination of milk, cream and whey, by acidification or the combination of acidification and heat. Coagulation will normally occur at the isoelectric point of casein, i.e. around pH 4.6, or, in the case where heating is used, at a higher pH. The acidification can be accomplished by the conversion of lactose to lactic acid by microbial starter organisms, by addition of acidogens such as glucono-delta-lactone, by addition of acid whey powder, by direct addition of acids such as lactic acid, acetic acid or citric acid, or, by any other method known in the art. One type of acid curd cheese is Ricotta cheese. Ricotta cheese is normally produced from whole or partly skimmed milk, or whey, or a mixture of milk and whey. Manufacture of Ricotta cheese includes heating the milk or whey or milk/whey mixture to a temperature sufficient for coagulation of the protein.

In one embodiment the whey protein hydrolysate is added to the cheese milk prior to, at the same time as, or after, the addition of coagulant. The whey protein hydrolysate may be mixed with the cheese milk by any suitable method known in the art, such as stirring or homogenisation.

A further aspect of the invention relates to the food product obtainable by using the whey protein hydrolysate as an ingredient in the production of a food product.

### EXAMPLES

### Example 1

Preparation of Whey Protein Hydrolysate and Use of Hydrolysate as Ingredient in Pizza Cheese

Whey protein (34% crude protein, Land-O-lake) was dissolved in water to yield a 30% solution with pH about 6.5. One batch of the whey protein solution was incubated with 1% (w/w of protein content) of the metaloprotease NS46013 (0.858 AU/g, Novozymes, Denmark), and one batch was incubated with 2% (w/w of protein content) of the non-metaloprotease SP446 (0.84 AU/ml Novozymes, Denmark). Both batches were incubated at 50° C. for 1 hour and then heat treated at 88° C. for 30 min. The hydrolysate was further subjected to a single step homogenisation at 1000 psi and 50° C. (utilising the single stage of a two stage Gaulin homogenizer) and stored under refrigeration until use for cheese making.

3 batches of cows milk (Holstein and Jersey breed of The California Polytechnical University dairy Herd) were standardised to 3-4% w/w fat and pasteurised at 76° C. for 16 seconds. Whey protein hydrolysate prepared with NS46013 and SP446 respectively, was added to each of two batches of milk to accomplish a level of addition of 28-32% added whey proteins of the total percentage of milk protein. The third batch of milk was used as control. 0.015% w/w of a mixture of StrC-5 and LB-12 DVS cultures (Chr. Hansen, Milwaukee, Wis.) and 0.09% w/w of Chymax rennet (Chr. Hansen, Milwaukee, Wis.) was added to each batch. The milk was allowed to coagulate for 45 min at 33° C., before cutting. The cheese curd had a healing time of 5 minutes with no agitation and additional 10 minutes of slow agitation before cooking. The curd/whey mixture was heated at a rate of 0.5° C. per minute for the first 30 minutes to a final cooking temperature of 44° C. Temperature was maintained at 44° C. until pH reached 6.10-5.9. Approximately 50% of the whey was drained, and the curd was left in the remaining whey with occasional agitation until pH reached 5.2, when the rest of the whey was drained, and 2.5% w/w salt was mixed with the curd. The curd was transferred to mozzarella cooker-stretcher (SSF Inc., Columbus, Wis.) and cooked and stretched in 71° C. water at a speed set at 60%. The stretched curd was placed into ice water upon leaving the cooker and held submerged for approximately one hour.

Actual cheese yield was calculated as kg of cheese per 100 kg of milk.

Moisture adjusted cheese yield is expressed as the actual yield adjusted to a standard level of moisture. Moisture adjusted yield is calculated by multiplying the actual yield and the ratio of actual moisture content/standard moisture according to the following formula:

Y_{adj}=Y_{act}×1−(M_{act}/1−M_{std})

Where Y_{adj}=adjusted yield, Y_{act}=actual yield, M_{act}=actual fractional moisture content, M_{std}=standard fractional moisture content (0.48)

Cheese meltability was measured by Schreiber test. Cheese samples of equal weight and dimensions were heated in the oven at 100° C. for 14 minutes and meltability was expressed as the percent increase in the area of the underlying surface covered by the cheese.

Results

Cheese yield (with and without adjustment for moisture) and meltability is shown in table 1.

TABLE 1

| | | NS46013 whey | |
|---|---|---|---|
| | | protein hydrolysate | SP446 whey protein |
| | Control | added | hydrolysate added |
| Yield (%) | 10.6 | 12.10 | 12.3 |
| Moisture adjusted | 11.75 | 12.83 | 12.6 |
| yield (%) | | | |
| Meltability | 4.42 | 4.19 | 3.42 |

The results in table 1 show that a comparable increase in cheese yield is achieved when adding whey protein hydrolysate produced with either the metaloprotease NS46013 or the non-metaloprotease SP446, compared to yield of the control cheese. It is surprisingly found that the meltability of cheese with NS46013 whey protein hydrolysate is comparable to the meltability of the control cheese, whereas the meltability of the cheese with SP446 whey protein hydrolysate is considerably poorer than the control cheese.

1. A method for producing a whey protein hydrolysate, comprising:
a) adding a metaloprotease to a composition comprising whey protein;
b) heat treating said composition at a temperature of between 80 and 98° C.

2. The method of claim 1, wherein said metaloprotease is derived from Bacillus amyloliquefaciens.

3. The method of claim 1 or claim 2, wherein said metaloprotease belongs to peptidase family M4.

4. The method of any of the claims 1-3 wherein the amount of protease added in step a) is between 0.01 and 10 AU per g whey protein.

5. The method of any of the claims 1-3, wherein the amount of protease added in step a) is between 0.1 and 5 AU per g whey protein.

6. The method of any of the claims 1-3, wherein the amount of protease added in step a) is between 0.2 and 2 AU per g whey protein.

7. The method of any of the claims 1-6, wherein said heat treatment is conducted at a temperature sufficient to inactivate the enzyme.

8. The method of any of the claims 1-7, wherein said heat treatment is conducted at a temperature sufficient to induce gelation.

9. The method of any of the claims 1-8, wherein said heat treatment is conducted at a temperature of between 85 and 95° C.

10. The method of any of the claims 1-9, wherein the pH of said whey protein composition is between 4 and 9.

11. The method of any of the claims 1-9, wherein the pH of said whey protein composition is between 5 and 8.

12. The method of any of the claims 1-9, wherein the pH of said whey protein composition is between 6 and 7.

13. A whey protein hydrolysate produced by the method of any of the claims 1-12.

14. The method of any of the claims 1-12, further comprising using the whey protein hydrolysate as ingredient in the production of a food product.

15. The method of claim 14, wherein said food product is cheese.

16. The method of claim 15, wherein said cheese is a stretched curd cheese.

17. The method of claim 15 or claim 16, wherein said cheese is a pizza cheese.

18. The method of claim 15, wherein said cheese is a Ricotta cheese.

19. The method of any of the claims 15-18, wherein said cheese is produced for use as a food ingredient.

20. The method of any of the claims 15-19, wherein the whey protein hydrolysate is added to the cheese milk prior to the addition of coagulant.

21. The method of claim 20, further comprising homogenising the cheese milk after addition of the whey protein hydrolysate.

22. A food product produced by the method of claim 14

23. A cheese produced by the method of any of the claims 15-21.
